(19) United States
(12) Patent Application Publication
(10) Pub. No.: US 2026/0262613 A1
(43) Pub. Date: Sep. 10, 2026

(54) Aquaculture net cleaner head controller

(71) Applicant: Lindgren-Pitman, Inc., Pompano Beach, FL (US)

(72) Inventors: Joshua De Santiago, Pompano Beach, FL (US); Peter B. Lindgren, Pompano Beach, FL (US)

(21) Appl. No.: 19/555,991

(22) Filed: Mar. 4, 2026

Related U.S. Application Data
(60) Provisional application No. 63/766,520, filed on Mar. 4, 2025.

(51) Int. Cl. A01K 63/04; F03B 11/08; F03B 15/08

(52) U.S. Cl. CPC A01K 63/047; F03B 11/08; F03B 15/08

(57) ABSTRACT

A system for clearing debris from propellers in aquaculture net cleaning system. The system employs a controller having a cleaning head with a plurality of propellers. When debris accumulates on the propellers, the controller will perform cleaning steps by reversing specific propellers at reduced speeds in a sequential manner to dislodge the debris while maintaining the forward operation of other propellers to sustain the cleaning head position on the net. The controller includes adjustable parameters, including propeller speed and reversal duration to optimize the process based on fouling conditions and net types. A predetermined sequence ensures efficient debris removal without the need for manual intervention or loss of cleaning location.

### PRIORITY CLAIM

This application is based upon and claims the priority date of U.S. Provisional Patent Application entitled AQUACULTURE NET CLEANER HEAD CONTROLLER, application number 63/766,520 filed 03/04/2025 the content of which is incorporated herein by reference.

### FIELD OF THE INVENTION

The present invention relates to the field of aquaculture fish farming and, more specifically, to an apparatus and method for removing debris from aquaculture net cleaner heads.

### BACKGROUND OF THE INVENTION

Fish farming, often called aquaculture in offshore ocean environments, is responsible for a large part of fish supply for human consumption. Cleaning marine fouling from or replacing nets to maintain good water flow and healthy conditions is often one of the largest expenditures of money and resources associated with offshore fish farming.

The nets used in fish farming may consist of a predator net and a grow out net. The predator net typically has mesh opening of about 3-4 inches designed to prevent predators from entering the fish farm area. Grow out nets have much smaller mesh and may have square or hexagonal openings of ½ to 1 ½ inch across. Both grow out nets and predator nets need to be kept clean. In the past nets were treated with poison antimicrobials to reduce fouling growth. The antimicrobial ingredients are no longer permitted on most fish farms which substantially increases the frequency of net cleaning. Increased farm densities amplify the problems and every effort is being made to improve net design and provide maintenance of nets. During winter months cleaning of the nets may be required only every 2 months. During summer months a cleaning may be needed every 10 days. If the nets are not cleaned, marine growth can easily get out of control risking proper water flow, reduced disolved oxygen, slower growth and increased mortalities.

Net cleaning systems employ one or more cleaning heads with multiple propellers that interact with the net. These cleaning heads are constructed and arranged to remove debris and marine growth, such as algae, slime, barnacles and other organic material, without affecting the structural integrity of the nets. However, certain challenges persist in existing systems, particularly when dealing with long, stringy, or leafy debris that can entangle or foul the cleaning head propellers so as to reduce cleaning efficiency.

Applicant’s Patent 11,523,595 discloses the net cleaning system using propeller-driven cleaning heads that apply vibratory motions to dislodge debris and marine growth. Applicant’s Patent 11,932,492 discloses an aquaculture cleaning system with enhanced remote electronic control of propellers and tracks to improve cleaning precision and performance. Applicant’s Patent 11,116,118 provides a method for propelling a cleaning head.

While the above cleaning heads effectively remove marine fouling from nets, they do not address fouling of the cleaning head itself. Debris growth on the cleaner head propeller tips will reduce the efficiency of the propellers. Significant debris can accumulate around the propellers to a point that requires intervention. In such cases, operators may reverse operation in an effort to clear the debris. However. uncontrolled propeller reversing can result in partial or full disengagement of the cleaning head from the net, causing operators to lose their working location and necessitating additional time to reposition the cleaning head. Further, if the propellers are not timely cleaned, cleaning performance suffers and the cleaning head will need to be retrieved from operation which is both time consuming and labor intensive.

### SUMMARY OF THE INVENTION

The present invention includes an apparatus and method for removing debris that may foul a cleaning head propeller used in aquaculture net cleaning systems. The invention includes a method and apparatus capable of reversing the fouling cleaning the cleaning head propeller.

In the preferred embodiment, each propeller on a cleaning head is capable of rotating in both forward and reverse direction. A drive system is operatively connected to the hub of the propeller to control the rotational direction and speed of the propeller, and a controller is configured to selectively reverse the rotational direction of at least one propeller while maintaining the forward rotational direction of at least one other propeller. The controller also adjusts the rotational speed of the reversed propeller to a reduced speed to facilitate debris removal and subsequently returns the reversed propeller to the forward direction once the debris is cleared.

The cleaning head of a preferred embodiment uses four propellers arranged in counter-rotating pairs to balance side thrust during operation. The controller is configured to operate the propellers in a predetermined sequence of stages, which alternates the reversal and forward operation of the propellers.

The sequence may include a pause between stages during which all propellers are slowed or stopped before reversing to ensure smooth transitions and effective debris removal.

The apparatus allows operator interface for the adjustment of parameters such as selecting the propellers to be reversed, adjusting the rotational speed of the reversed propellers, inputting the duration of the reversal, and setting the timing of transitions between forward and reversed directions. The cleaning head is designed to maintain a net-positive forward thrust during debris removal to ensure it stays engaged with the aquaculture net surface.

The method of the present invention involves operating a plurality of propellers in a forward rotational direction to clean an aquaculture net, reversing the rotational direction of at least one propeller while maintaining the forward rotational direction of others, adjusting the reversed propeller’s speed to a reduced speed, and returning the reversed propeller to forward rotation after debris is cleared. The method may also include operating the cleaning head in a predetermined sequence of stages and monitoring fouling conditions to automatically adjust propeller operations during cleaning.

An objective of the present invention is to provide an apparatus and method for removing debris from cleaning head propellers in aquaculture net cleaning systems, thus reducing downtime and improving operational efficiency.

Another objective of the present invention is to maintain the position of a cleaning head on the aquaculture net during debris removal, thus preventing disengagement or loss of cleaning location.

Yet another objective of the present invention is to enable operators to customize cleaning parameters, including propeller selection, speed, reversal duration, and transition timing, to optimize performance based on fouling and net conditions.

A further objective of the present invention is to implement a predetermined sequence of stages for cleaning head propeller operation, thus ensuring effective and automated debris removal without requiring manual intervention.

It will also be appreciated that various combinations of the features disclosed hereafter for an apparatus for removing debris from propellers are also possible as desired.

### BRIEF DESCRIPTION OF THE FIGURES

The present invention is illustrated and described herein with reference to the various drawings, in which like reference numbers are used to denote like system components/method steps, as appropriate, and in which:

FIG. 1 is a perspective view of a single propeller;

FIG. 2 is a perspective view of a four propeller assembly;

FIG. 3 is a front view of the propeller assembly;

FIG. 4 is a front view of the propeller assembly with propellers 1 and 3 in a forward direction and propeller 2 and 4 in a rearward direction;

FIG. 5 is a front view of the propeller assembly with propellers 1 and 2 in a rearward direction and propeller 3 and 4 in a forward direction;

FIG. 6 is a front view of the propeller assembly with propellers 1 and 2 in a forward direction and propeller 3 and 4 in a rearward direction.

### DETAILED DESCRIPTION OF THE INVENTION

While the present invention is susceptible of embodiment in various forms, there is shown in the drawings and will hereafter be described a presently preferred, albeit not limiting, embodiment with the understanding that the present disclosure is to be considered an exemplification of the present invention and is not intended to limit the invention to the specific embodiments illustrated.

The controller can be adapted to the receipt of manual instructions, preprogrammed instructions, activation by timed cleaning or automatic activation, wherein the propeller for a cleaning head is cleaned on a regular or on demand basis thereby addressing a fouled propeller without the need for removal of the cleaning head from operation. The controller allows for debris clearing of the propeller while maintaining the position and forward thrust of the cleaning head on the net. In one embodiment, the system employs a predetermined sequence in which one or two propellers are reversed and operated at reduced speeds, while the remaining propellers continue their regular forward operation. In this embodiment, it is ensured that debris is cleared effectively without disengagement from the net and the associated risk of losing the cleaning head positioning. Maintaining a cleaning head position is especially important when the cleaning head is on a mapped program designed to efficiently clean a net without overlapping cleaning.

In manual operation, the operator can adjust various parameters, such as propeller selection, speed, and sequence duration, to optimize cleaning for specific fouling conditions and net types without affecting a preprogrammed map. This level of customization and automation reduces the frequency of manual debris removal and increases overall cleaning efficiency.

This invention effectively tackles the key shortcomings of existing systems by offering a more practical and efficient solution for aquaculture net cleaning. By enabling operators to clear debris without disengaging the cleaning head or losing position on the net, the system minimizes downtime and boosts productivity. The ability to fine-tune the sequence and speed of the propellers for different conditions ensures that the system can handle a wide range of fouling scenarios. This method represents a needed improvement in the reliability and performance of net cleaning operations in aquaculture.

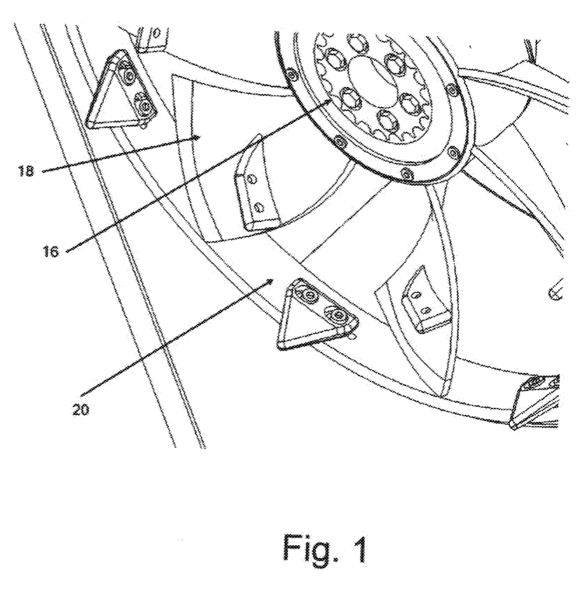

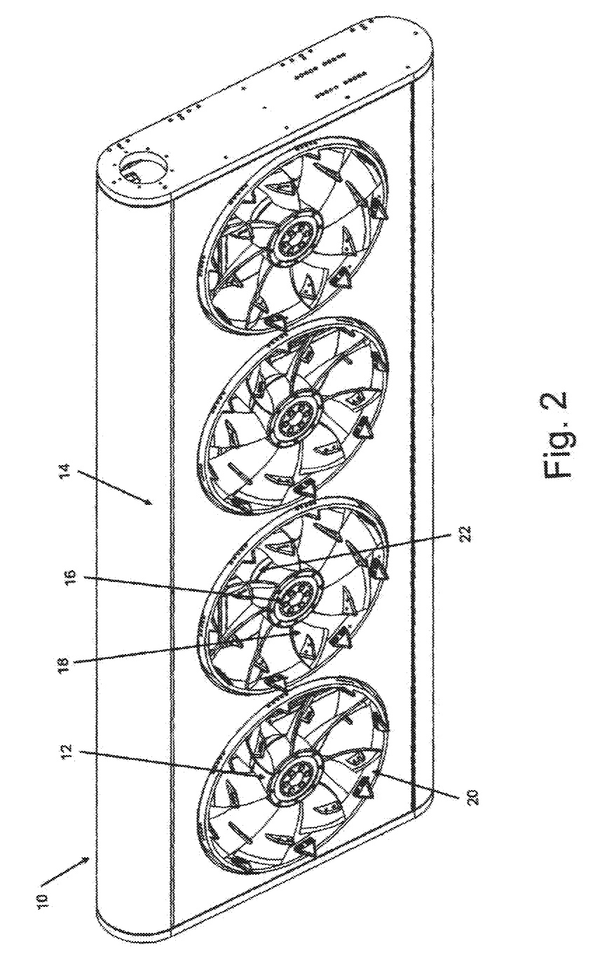

Referring to FIGS. 1 and 2, illustrated is the apparatus 10 operated by a controller, the apparatus includes a cleaning head 12 mounted on a frame 14. The cleaning head 12 itself includes a hub 16, to which a plurality of propellers 18 is mounted. Each propeller 18 is designed to rotate in both forward and reverse directions allowing it to perform cleaning and debris removal tasks. A perimeter rim 20 is formed along the outer edge of the propellers 18 and serves as a mounting point for additional cleaning features, namely knuckles.

The propellers 18 are driven by a drive system 22 operatively connected to the hub 16. The drive system 22 is configured to control the rotational direction and speed of the propellers 18 which allows for precise adjustments during cleaning operations. The drive system 22 is powered by an electric or hydraulic motor designed to provide sufficient thrust to keep the cleaning head 12 engaged with the aquaculture net during operation.

A control unit 24 is operatively connected to the drive system 22 and is responsible for managing the operation of the propellers 18. The control unit 24 selectively reverses the rotational direction of one or more propellers 18 while maintaining the forward rotational direction of at least one other propeller 18. This feature ensures that the cleaning head 12 remains engaged with the net while debris is dislodged. The control unit 24 also adjusts the rotational speed of the reversed propellers 18 to a reduced speed to facilitate debris removal and subsequently returns them to forward rotation after the debris has been cleared.

The apparatus 10 may include a monitoring system to detect fouling conditions on the propellers 18 which would communicates with the controller for automatic adjustments to operational parameters, such as propeller speed, rotational direction, and cleaning sequences, based on real-time fouling conditions of the propellers. For instance, fouling conditions refer to the presence and severity of unwanted material accumulation on the propeller blade surfaces that affects operation. These materials typically include biological growth like algae, seaweed, barnacles, mussels, and other marine organisms, as well as debris such as dirt or other particulates. In the context of the invention, fouling conditions describe the specific characteristics of this buildup that can affect the propeller efficiency.

The cleaning head 12 is designed to provide a net-positive forward thrust during operation which ensures that the apparatus 10 maintains engagement with the aquaculture net even during debris removal stages. Preferably the propellers 18 are arranged in counter-rotating pairs to balance side thrust and prevent lateral movement of the cleaning head 12.

In one embodiment, an operator interface 28 is provided to enable control and customization of cleaning parameters. The observation of poor cleaning performance can be seen on video behind the net cleaner. Through the interface 28, an operator can select specific propellers 18 for reversal, adjust the rotational speed of the reversed propellers 18, input the duration of the reversal, and set the timing of transitions between forward and reversed rotational directions.

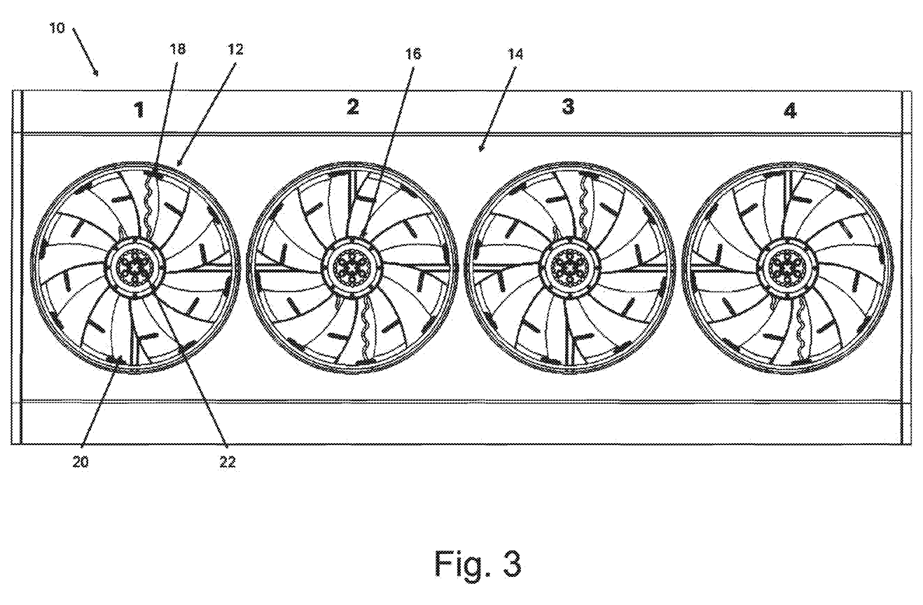

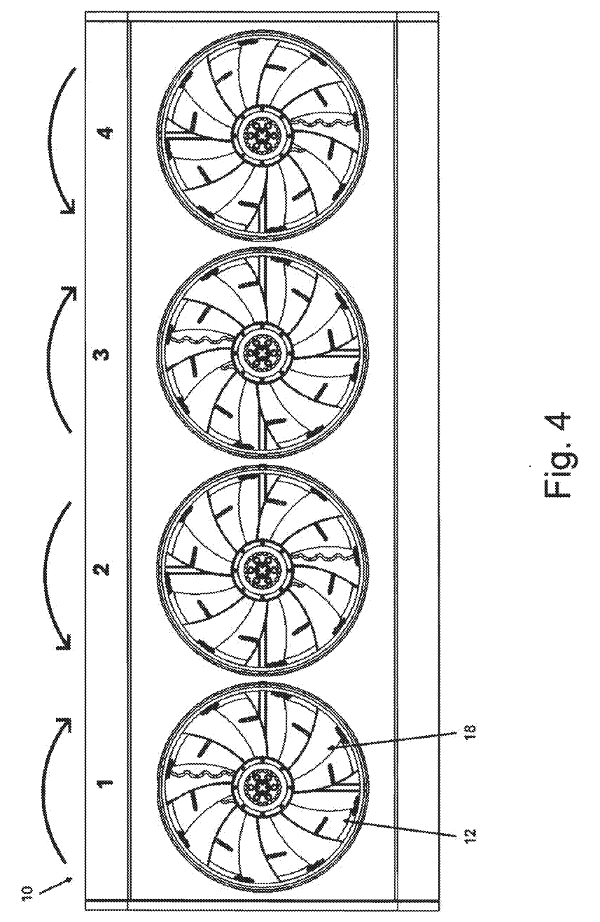

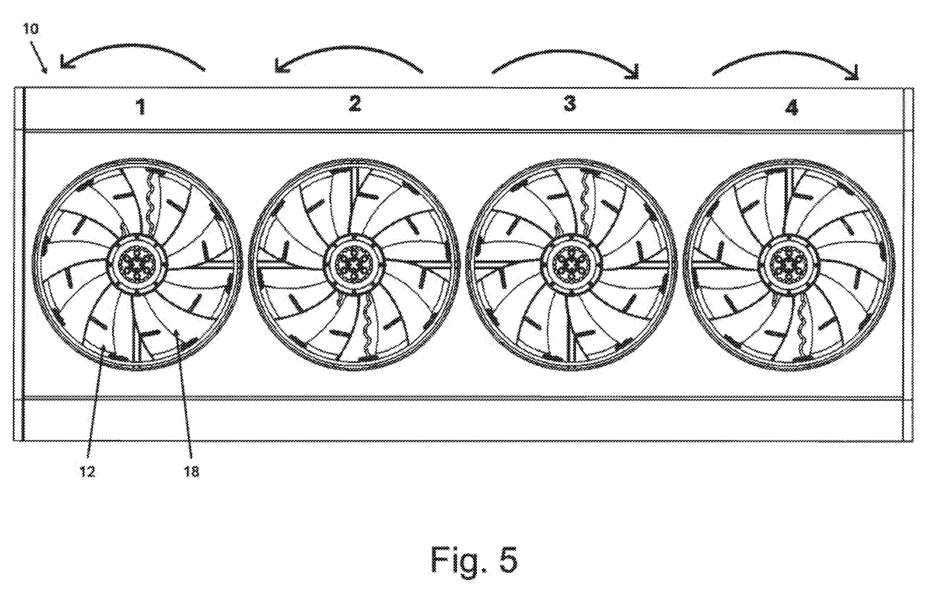

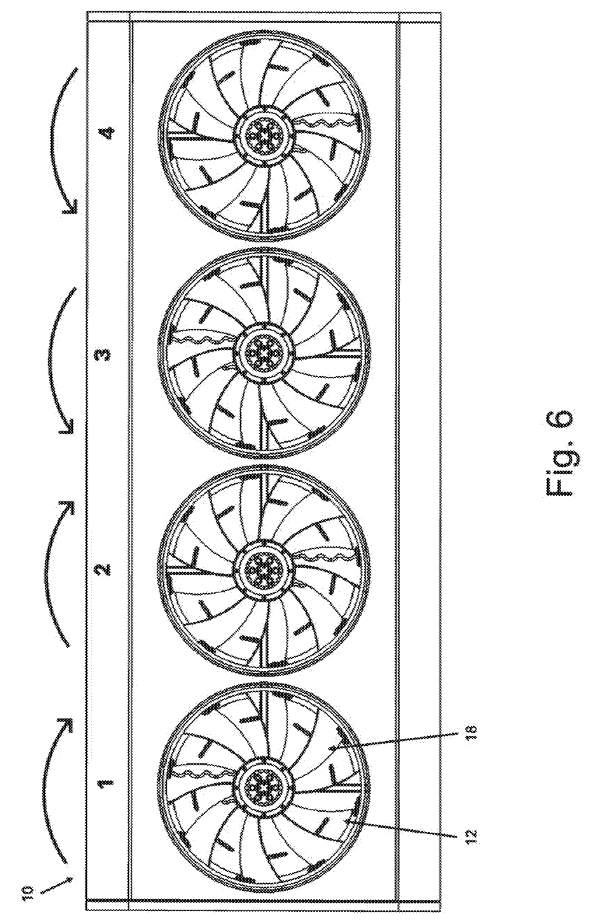

Referring now to FIG. 3, the apparatus 10 is depicted in a first stage of operation, wherein all propellers 18 rotate in a forward direction to clean the aquaculture net. FIG. 4 represents the apparatus 10 in a second stage of operation, wherein the first and third propellers operate in a forward position and the second and fourth propellers operate in a rearward direction. Referring to FIG. 5, the apparatus 10 is depicted in a subsequent stage, wherein the first and second propellers reverse direction to dislodge debris while the third and fourth propellers 18 resume forward rotation. FIG. 6 depicts the first and second propeller in the forward rotation and propellers 3 and 4 in a rearward direction. The series of stages in FIGS. 4-6 represent only an exemplary example of the method of efficiently cleaning debris from a plurality of propellers. The number and direction of the propellers in each stage is not limiting.

The method of the present invention involves operating the propellers 18 in a forward rotational direction during a first stage of cleaning. If debris accumulates, the control unit 24 initiates a second stage, reversing one or more propellers 18 to clear debris while maintaining forward rotation of others to ensure consistent engagement with the net. The method further includes the step of adjusting the rotational speed of the reversed propeller 18 to a reduced speed to facilitate debris removal while sustaining net engagement. Next, the method includes the step of returning the reversed propeller 18 to the forward rotational direction after clearing the debris. This process may then repeat as necessary, which ultimately solves the issues of requiring manual intervention and relocating the cleaning position for propellers 18 used in aquaculture net systems.

In one embodiment, the plurality of propellers 18 includes at least four propellers 18, and the reversing step includes reversing one or two propellers 18 while the remaining propellers 18 maintain their forward rotational direction. The method may include introducing a pause between stages, during which all propellers 18 are slowed or stopped to facilitate smooth transitions.

If needed, an operator can further adjust at least one of the following parameters to optimize debris removal by selecting the propellers 18 to be reversed, adjusting rotational speed of the reversed propellers 18, inputting the duration of the reversal, and setting the timing of transitions between forward and reversed rotational directions.

The term "coupled" is defined as connected, although not necessarily directly, and not necessarily mechanically. The use of the word "a" or "an" when used in conjunction with the term "comprising" in the claims and/or the specification may mean "one," but it is also consistent with the meaning of "one or more" or "at least one." The terms "comprise" (and any form of comprise, such as "comprises" and "comprising"), "have" (and any form of have, such as "has" and "having"), "include" (and any form of include, such as "includes" and "including") and "contain" (and any form of contain, such as "contains" and "containing") are open-ended linking verbs. As a result, a method or device that "comprises," "has," "includes" or "contains" one or more steps or elements, possesses those one or more steps or elements, but is not limited to possessing only those one or more elements. Likewise, a step of a method or an element of a device that "comprises," "has," "includes" or "contains" one or more features, possesses those one or more features, but is not limited to possessing only those one or more features.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims.

What is claimed is:

1. A method for removing debris from propellers in an aquaculture net cleaning system, the method comprising:
operating a plurality of propellers on a cleaning head in a forward rotational direction to clean an aquaculture net;
reversing the rotational direction of at least one propeller while maintaining the forward rotational direction of at least one other propeller to maintain position on the aquaculture net;
adjusting the rotational speed of the reversed propeller to a reduced speed to facilitate debris removal while sustaining net engagement; and
returning the reversed propeller to the forward rotational direction after clearing the debris.

2. The method of claim 1, including the step of operating the cleaning head in a predetermined sequence of stages, wherein each stage alternates which propellers are reversed and adjusts their rotational speed to optimize debris removal.

3. The method of claim 2, wherein the predetermined sequence of stages includes:
directing all propellers to operate in the forward rotational direction;
reversing at least one propeller and slowing the propeller while maintain forward rotational direction and speed.

4. The method of claim 3, including the step of sequencing wherein a timed pause is introduced between stages during which all propellers are slowed or stopped before reversing.

5. The method of claim 1, wherein the operator can adjust at least one of the following parameters to optimize debris removal by:
selecting the propellers to be reversed;
adjusting rotational speed of the reversed propellers;
inputting the time duration of the reversal;
setting the timing of transitions between forward and reversed rotational directions.

6. The method of claim 1, including the step of monitoring and automatically adjusting the sequence of propeller operations based on fouling conditions.

7. A controller for an aquaculture net cleaning system, said aquaculture net cleaning system including a cleaning head with a plurality of propellers with impact knuckles coupled to a drive system for rotational control of said propellers and configured for positioning the cleaning head against an aquaculture net surface wherein rotation of said propellers drives the cleaning head against the net surface and said impact knuckles impacts the net surface causing removal of debris from said propellers, said controller comprising:
a control unit coupled to said drive system allowing clockwise or counter clockwise rotational of each propeller wherein at least one said propeller maintains a forward rotational direction to maintain said cleaning head against the net surface and at least one other propeller is reversed to dislodge debris from propeller blades;
a speed control coupled to said control unit and configured to adjust the rotational speed of each propeller to maintain said cleaning head against said net surface while at least one propeller is reversed.

8. The apparatus of claim 7, wherein said cleaning head has four propellers arranged in pairs, each pair being counter-rotating to balance side thrust during operation.

9. The apparatus of claim 7, wherein the control unit is further configured to operate the propellers in a predetermined sequence of stages to optimize debris removal from propeller reversal, wherein each stage alternates which propellers are reversed.

10. The apparatus of claim 9, wherein the sequence includes a first stage in which all propellers operate in the forward rotational direction and a predetermined speed and a second stage in which at least one propeller is reversed and rotation slowed to a second predetermined speed.

11. The apparatus of claim 9, wherein the sequence of stages is further configured to introduce a pause between stages, wherein all the propellers are slowed or stopped before reversing.

12. The apparatus of claim 7, further comprising an interface operable by an operator to adjust at least one of the following parameters:
selecting the propellers to be reversed;
adjusting the rotational speed of the reversed propellers;
inputting the duration of the reversal; and
setting the timing of transitions between forward and reversed rotational directions.

13. The apparatus of claim 7, wherein the cleaning head is configured to provide a net-positive forward thrust during debris removal to maintain its position on the aquaculture net.
